(19) United States
(12) Patent Application Publication
(10) Pub. No.: US 2015/0062092 A1
(43) Pub. Date: Mar. 5, 2015

(54) BASELINE CALIBRATION METHOD AND SYSTEM THEREOF FOR TOUCH PANEL

(71) Applicant: ILI TECHNOLOGY CORP., Hsinchu County (TW)

(72) Inventors: CHIH-JEN CHENG, HSINCHU CITY (TW); CHENG-CHUNG HSU, HSINCHU COUNTY (TW)

(73) Assignee: ILI TECHNOLOGY CORP., Hsinchu County (TW)

(21) Appl. No.: 14/093,455

(22) Filed: Nov. 30, 2013

(30) Foreign Application Priority Data
Sep. 4, 2013 (TW) 102131895

(51) Int. Cl. G06F 3/041

(52) U.S. Cl. CPC G06F 3/0418; G06F 2203/04103
USPC 345/178

(57) ABSTRACT

An exemplary embodiment of the present disclosure illustrates a baseline calibration method for touch panel. Firstly, the baseline calibration method calculates each first differential value associated with each respective transmission electrode through a first-axis calculation procedure. Next, the baseline calibration method calculates each second differential value associated with each respective sensing electrode through a second-axis calculation procedure. Finally, the baseline calibration method calculates a baseline calibration value based on each of the first differential values and each of the respective second differential values calculated.

### BACKGROUND

1. Technical Field

The present disclosure relates to a baseline calibration method; in particular, to a baseline calibration method and a system thereof for touch panel.

2. Description of Related Art

Recently, great improvements have been made to the touch sensing technology, which greatly increases its convenience of use. Because touch panels have advantages such as small volume, low cost, low power consumption and long life time. Therefore, the technology for the touch sensing has been widely used in various types of electrical devices.

Some of the manufacturers integrate pressure sensors in the touch panel during the manufacturing process of the touch panel to reduce the manufacturing cost of touch panel while meet the current design trend of light, thin, and compact. However, the pressure sensor may sense the pressing point when the user does nothing because of the components of the factors which aren't predicated drift in the process, that is the “Initial Touch Point”, and so as to affect the accuracy when operating the touch panel. Furthermore, the above issue may get worse with the area of the touch panel increasing suddenly. In the other hand, there usually exists mismatch between the each sensing channel on the touch panel. When the users do nothing, every sensing channel receives the value of the initial touch points may be different, causing to decrease the preciseness and inducing inconvenient to the users.

Thus, calibrating the initial touch point is one of the important factors to operate correctly and detect the user action in accuracy for touch panel.

### SUMMARY

An exemplary embodiment of the present disclosure provides a baseline calibration method for a touch panel. The baseline calibration method comprises calculating each first differential value associated with each respective transmission electrode through a first-axis calculation procedure, calculating each second differential value associated with each respective sensing electrode through a second-axis calculation procedure and calculating a baseline calibration value based on each of the first differential values and each of the respective second differential values calculated.

An exemplary embodiment of the present disclosure provides baseline calibration system. The baseline calibration system comprises a touch panel and a baseline calibration unit. The baseline calibration unit is coupled to the touch panel. The touch panel having a plurality of transmission electrodes and sensing electrodes disposed thereon, the transmission electrodes being arranged on the touch panel along a first axis and the sensing electrodes being arranged along a second axis, wherein each of the transmission electrodes and each of the respective sensing electrode form a crossover point. The baseline calibration unit calculates each first differential value associated with each transmission electrode through a first-axis calculation procedure and calculates each second differential value associated with each sensing electrode through a second-axis calculation procedure; the baseline calibration unit calculates a baseline calibration value based on each of the first differential value and each of the respective second differential value.

To summary up, the manufacturing company of the touch panel can improve the judgment accuracy decreased when users employ the touch panel. The improvement exploits the baseline calibration unit to resolve the mismatch between each sensing channel or the manufacturing for touch panel originally, and the mismatch may further affect the judgment accuracy. Firstly the baseline calibration unit calibrates the crossover points arranged with first-axis, secondly the baseline calibration unit bases on the result of calibrating the crossover points arranged with first-axis to calibrate the crossover points arranged with second-axis again, so as to cancel the part of the un-flatness for each axis. Therefore, the baseline calibration unit achieves the gradient approximating agreed for whole touch panel, so as to increase the judgment accuracy. It's worth noting, wherein using the method arranged with first-axis and second-axis to calibrate the crossover points may reduce the circuit cost by N²−2N.

In order to further the understanding regarding the present disclosure, the following embodiments are provided along with illustrations to facilitate the disclosure of the present disclosure.

### BRIEF DESCRIPTION OF THE DRAWINGS

FIG. 1 shows a diagram of a baseline calibration system according to an embodiment of the present disclosure;

FIG. 2 shows a diagram of a touch panel according to an embodiment of the present disclosure;

FIG. 3 shows a flow diagram of a baseline calibration method according to an embodiment of the present disclosure;

FIG. 4 shows a flow diagram of a baseline calibration method according to other embodiment of the present disclosure;

FIG. 5 shows a flow diagram of a baseline calibration method according to another embodiment of the present disclosure.

### DETAILED DESCRIPTION OF THE EXEMPLARY EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

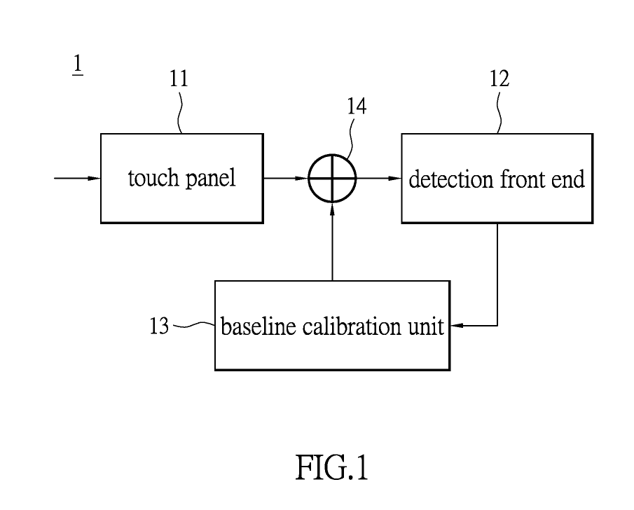

Please refer to FIG. 1, FIG. 1 shows a diagram of a baseline calibration system according to an embodiment of the present disclosure. The baseline calibration 1 system includes a touch panel 11, an operating unit 14, a detection front end 12 and a baseline calibration unit 13. The detection front end 12 is coupled to the touch panel 11, the baseline calibration unit 13 is coupled to the detection front end 12 and the operating unit 14 is coupled between the touch panel 11 and the detection front end 12. In addition, the output of the baseline calibration unit 13 is coupled to the operating unit 14.

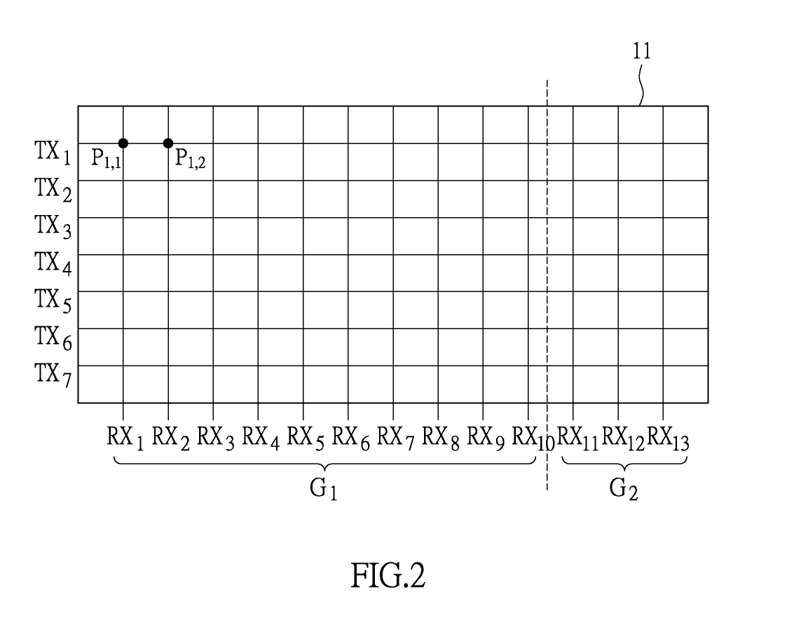

Please refer to FIG. 2, FIG. 2 shows a diagram of a touch panel according to an embodiment of the present disclosure. The touch panel 11 includes a plurality of transmission electrodes TXᵢ on first-axis and a plurality of sensing electrodes RXⱼ on second-axis, each transmission electrodes TXᵢ and each sensing electrodes RXⱼ form each crossover point wherein the i, j≧1 and the i, j are integers. For instance, shown as FIG. 2, the touch panel 11 has the transmission electrodes TX₁˜TX₇ on first-axis and the sensing electrodes RX₁RX₁₃ on second-axis. Each transmission electrodes TXᵢ and each sensing electrodes RXⱼ form each crossover point P_{i,j}, such as the crossover point P_{1,1} formed by the transmission electrodes TX₁ and the sensing electrodes RX₁, or the crossover point P_{1,2} formed by the transmission electrodes TX₁ and the sensing electrodes RX₂.

The baseline calibration system 1 further includes an analogy-to-digital converter (not illustrated), the analogy-to-digital converter is the circuit for transforming the received continues analogy signal to discrete digital signal and then measuring the discrete digital signal, wherein the expression is the digital signal in fixed ratio voltage usually. The digital signal may be outputted by different coding type. The analogy-to-digital converter provides the digital signal to the detection front end 12. In more specifically, when the scanning signals scan the transmission electrodes TXᵢ on the touch panel, sensing the sensing values of the crossover points P_{i,j} on the sensing electrodes RXⱼ corresponded to the transmission electrodes TXᵢ, and then the sensing values are transformed from the analogy signal into the digital signal. After that, the values of digital signals are provided to the baseline calibration unit 13.

The operating unit 14 includes a first input terminal, a second input terminal and an output terminal. The first input terminal is coupled to the touch panel 11, the second input terminal is coupled to the baseline calibration unit 13, and the output terminal is coupled to the detection front end 12. The operating unit 14 is used for operating the baseline calibration value CRT(P_{i,j}) of the baseline calibration unit 13 received from the second input terminal and each crossover point P_{i,j} outputted by the touch panel 11, and then outputs the sensing value to calibrate each crossover point at the output terminal.

The detection front end 12 is coupled to the touch panel 11, which is being the multi-channels circuit of the signal transmission. The signal transmission channel of the detection front end 12 is used for receiving the sensing value of the crossover point P_{i,j} of the sensing electrode on the touch panel 11. In other words, the each channel of detection front end 12 is coupled to at least one of the sensing electrodes RXⱼ on the touch panel 11.

An end of the baseline calibration unit 13 is coupled to the detection front end 12, and another of the baseline calibration unit 13 is coupled to the operating unit 14. The baseline calibration unit 13 is the operating circuit or other calculating circuit having the same function. The baseline calibration unit 13 receives the transformed scanning signal by the detection front end 12. When the scanning signals scan the transmission electrodes TXⱼ sequentially, sensing the sensing value of the crossover point P_{i,j} on the transmission electrodes TXⱼ by the sensing electrodes RXⱼ corresponding to the transmission electrodes TXⱼ.

The baseline calibration unit 13 is used for executing the calculation procedures. Firstly, the baseline calibration unit 13 presets the predetermined reference value BKTH, which is the calibrating target for the user. Then, the baseline calibration unit 13 scans the transmission electrode TXᵢ on first-axis by at least one of the scanning signal SCANₐ(TXᵢ), and each transmission electrode TXᵢ has the “a” number of the scanning signal SCANₐ(TXᵢ), the “a”≧1 and the “a” is the integer. The each scanning signal SCANₐ(TXᵢ) of the scanning transmission electrode TXᵢ will calculate average AVGₐ (TXᵢ) associated with each scanning signal SCANₐ(TXᵢ). The average AVGₐ (TXᵢ) calculates the all crossover point P_{i,j} associated with the transmission electrode TXᵢ by averaging, when each scanning signal SCANₐ(TXᵢ) scans the transmission electrode TXᵢ. Following, the baseline calibration unit 13 further bases on the predetermined reference value BKTH in the search process to calculate the first differential value DIF(TXᵢ) associated with the transmission electrode TXᵢ from the averages AVGₐ (TXᵢ) of the scanning signals SCANₐ(TXᵢ). On the other hand, when in the calculation process, the first differential value DIF(TXᵢ) of each transmission electrode TXᵢ stores a respective set of least significant bits (LSB) TXᵢ_{_{—}}LSB(RXⱼ) to the value of the sensing electrode RXⱼ calculating.

Hereafter, the baseline calibration unit 13 obtains the each average value AVG (RXⱼ) of the sensing electrode RXⱼ by averaging the sensing value of the all crossover point P_{i,j} associated with the sensing electrode RXⱼ, and obtaining the baseline calibration value CRT(P_{i,j}) by calculating the average value AVG (RXⱼ) with the set of least significant bits (LSB) TXᵢ_{_{—}}LSB(RXⱼ). Finally, posting back the each calculating baseline calibration value CRT(P_{i,j}) to the operating unit 14, so as to calibrate each crossover point P_{i,j} calculated by the baseline calibration value CRT(P_{i,j}).

For instance, please refer to the FIGS. 1 and 2, when the scanning signal scans the sensing electrode TX₁, the analogy-to-digital converter transforms the analogy type to the digital signal type for the scanning signal corresponding with the sensing value of the crossover point P_{1,1}, P_{1,2} . . . , P_{1,13} associated with the sensing electrode RX₁, RX₂, . . . , RX₁₃. Then the detection front end 12 outputs the sensing value transformed as the digital signal type to the baseline calibration unit 13.

When scans the transmission electrode TX₁ arranged along first-axis, providing the binary type scanning signal 1000, 0100, 0110 and 0101 to scan the transmission electrode TX₁ (i.e. the each bit set shows as the scanning signal SCAN₁(TX₁)˜SCAN₄(TX₁)). The sensing electrodes RX₁˜RX₁₃ obtain the sensing values of every crossover points P_{1,1}, P_{1,2} . . . , P_{1,13} associated with the transmission electrode TX₁ when the scanning signal 1000 is signaled onto the transmission electrode TX₁. At the same time, the baseline calibration unit 13 averages the sensing values of the all crossover points P_{1,1}, P_{1,2} . . . , P_{1,13} to obtain the average AVG₁(TX₁) belonging to the scanning signal 1000. Following, calculating the scanning signals 0100, 0110 and 0101 sequentially and obtaining the every averages AVG₂(TX₁)˜AVG₄(TX₁) belonging to the scanning signals 0100, 0110 and 0101, the calculating is same as scanning signal 1000, so it doesn't repeat here. It's worth noting, when processing the each scanning signals SCAN₁(TX₁)˜SCAN₄(TX₁), the baseline calibration unit 13 further bases on the predetermined reference value BKTH to calculate the first differential value DIF(TX₁) for the transmission electrode TX₁ from the scanning signals SCAN₁(TX₁)˜SCAN₄(TX₁). However, the scanning signals SCAN₂(TX)˜SCAN₄(TX₁) said is determined by the previous scanning signal. Such as the instance abovementioned, the 0100 of the scanning signal SCAN₂(TX₁) is determined according to the 1000 of the scanning signal SCAN₁(TX₁) and the predetermined reference value BKTH in the binary search algorithm.

Be more carefully, the 1000 of the scanning signal SCAN₁(TX₁) is signaled onto the transmission electrode TX₁ when processing the binary search. When the average AVG₁(TX₁) calculated is greater than the predetermined reference value BKTH, doesn't save. In other words, the bit of “1” for 1000 isn't saved, and then continuously signaling the 0100 of the scanning signal SCAN₂(TX₁).

Nevertheless, when the average AVG₂(TX₁) calculated for the 0100 of the scanning signal SCAN₂(TX₁) is less than the predetermined reference value BKTH, the bit of “1” for 0100 is saved in the binary search, and then continuously signaling the 0110 of the scanning signal SCAN₃(TX₁).

When the average AVG₃(TX₁) calculated for the 0110 of the scanning signal SCAN₃(TX₁) is greater than the predetermined reference value BKTH, the bit of 01“1”0 isn't saved in the binary search algorithm.

Finally, the 0101 of the scanning signal SCAN₄(TX₁) is signaled, when the average AVG₄(TX₁) calculated for the scanning signal SCAN₄(TX₁) is less than the predetermined reference value BKTH, the bit of 010“1” is saved in the binary search algorithm.

Therefore, calculating four scanning signals SCAN₁(TX₁)˜SCAN₄(TX₁) with the predetermined reference value BKTH to find the first differential value DIF(TX₁) (that is, the 0101 of the scanning signal SCAN₄(TX₁) in the example).

After calculated the first differential value DIF(TX₁) for the transmission electrode TX₁, calculating two sensing values for the 0101 of the first differential value DIF(TX₁) and the 0110 of the scanning signal SCAN₃(TX₁) respectively with the first differential value DIF(TX₁) in the process for the scanning electrode TX₁. The baseline calibration unit 13 will obtain and store each least significant bit TX₁_{_{—}}LSB(RX₁)˜TX₁_{_{—}}LSB(RX₁₃) on each sensing electrode RX₁RX₁₃ on the transmission electrode TX₁. Each least significant bit TX₁_{_{—}}LSB(RX₁)˜TX₁_{_{—}}LSB(RX₁₃) above may be expressed as follows:

TX₁_{_{—}}LSB(RXⱼ)=[SCAN₃(TX₁)_(RXⱼ)−SCAN₄(TX₁)_(RXⱼ)]/[SCAN₃(TX₁)−SCAN₄(TXᵢ)] (1)

Each least significant bit TX₁_{_{—}}LSB(RX₁)˜TX₁_{_{—}}LSB(RX₁₃) associated with each sensing electrode RX₁˜RX₁₃ belong to the temporary set of the first differential value DIF(TX₁) in the binary search algorithm. In the embodiment of present disclosure, while achieving by the binary search algorithm, but the person skill in the art should understand that can be implemented by replacing with other algorithm. The present disclosure is not limited thereto.

Sequentially executing the first differential value DIF(TX₂)˜DIF(TX₇) for the other transmission electrodes TX₂˜TX₇ after finishing the calculating of the first differential value DIF(TX₁) for the transmission electrode TX₁, and then completing the calculation procedure on first-axis. The calculation procedure is same as the transmission electrode TX₁, so it doesn't repeat here. It's worth noting, the sensing electrodes RXⱼ corresponding to every transmission electrodes TXᵢ are similar. In the other word, all sensing electrodes RXⱼ are coupled to the channels of the detection front end 12. Thus, after finishing the calculating of the first differential value DIF(TX₁) for the transmission electrode TX₁, obtaining the effect of each sensing electrodes RXⱼ to the transmission electrodes TXᵢ on the touch panel 11, also wouldn't calculate the first differential value DIF(TX₂)˜DIF(TX₇). Therefore, it could only use the first differential value DIF(TX₁) of the transmission electrode TX₁ being as other first differential values DIF(TX₂)˜DIF(TX₇) of the transmission electrodes TX₂˜TX₇, the present disclosure is not limited thereto.

Hereafter, the baseline calibration unit 13 finishes the calculation procedure for the transmission electrodes TX₁˜TX₇ arranged along first-axis, then calculating the sensing values of the sensing electrode RX₁ arranged along second-axis, that is the average AVG(RX₁) calculated by the sensing values associated with the each crossover point P_{1,1}, P_{2,1} . . . P_{7,1}. After calculating the average AVG(RX₁) for the sensing electrode RX₁, the baseline calibration unit 13 further calculates the average AVG(RX₁) with the least significant bits TX₁_{_{—}}LSB(RX₁)˜TX₇_{_{—}}LSB(RX₁) stored in the process of the first differential values DIF(TX₁)˜DIF(TX₇) for the transmission electrodes TX₂˜TX₇, and obtaining the second differential values DIF₁(RX₁)˜DIF₇(RX₁) for the sensing electrode RX₁. The second differential values DIF₁(RX₁)˜DIF₇(RX₁) for the sensing electrode RX₁ can be calculated by the equation (2) as following:

DIFᵢ(RXⱼ)=[AVG(RXⱼ)−BKTH]TXᵢ_{_{—}}LSB(RXⱼ) (2)

The baseline calibration unit 13 calculates the sensing value on the sensing electrode RX₂ sequentially to obtain the average AVG(RX₂) for the sensing electrode RX₂ by the values of the crossover points P_{1,2}, P_{2,2} . . . , P_{7,2}. Identically, the baseline calibration unit 13 calculates the average AVG(RX₂) with the least significant bits TX₁_{_{—}}LSB(RX₂)˜TX₇_{_{—}}LSB(RX₂) stored in the process of the first differential values DIF(TX₁)˜DIF(TX₇) for the transmission electrodes TX₁˜TX₇ after calculating the average AVG(RX₂) for the sensing electrode RX₂ by the equation (2), and obtaining the second differential values DIF₁(RX₂)˜DIF₇(RX₂) for the sensing electrode RX₁. Repeatedly, the baseline calibration unit 13 sequentially calculates the sensing electrodes RX₁˜RX₁₃ to obtain all the second differential values [DIF₁(RX₁)˜DIF₇(RX₁)], [DIF₁(RX₂)˜DIF₇(RX₂)] . . . , [DIF₁(RX₁₃)˜DIF₇(RX₁₃)] until completing the calculation procedure on second-axis.

Similarly, the method only calculates the transmission electrode TX₁ while doesn't calculate the transmission electrodes TX₂˜TX₇, thence the sensing electrode RX₁ also only bases on the transmission electrode TX₁ to calculate the second differential value DIF₁(RX₁) being as other second differential values DIF₂(RX₁)˜DIF₇(RX₁). In other words, the sensing values of the crossover points on the sensing electrodes RXⱼ are calibrated by the calculating result of the transmission electrode TX₁, the present disclosure isn't limited thereto.

Then, the baseline calibration unit 13 further calculates the calculating result for arranged along second-axis associated with the calculating result arranged along first-axis by the equation (3) as following:

CRT(P_{i,j})=DIF(TXᵢ)+DIFᵢ(RXⱼ) (3)

The baseline calibration unit 13 sequentially calculates all the baseline calibration values [CRT(P_{1,1}), CRT(P_{1,2}) . . . , CRT(P_{1,7})], [CRT(P_{2,1}), CRT(P_{2,2}) . . . , CRT(P_{2,7})]. . . , [CRT(P_{13,1}), CRT(P_{13,2}) . . . , CRT(P_{13,7})]. Finally, the baseline calibration unit 13 sends all the baseline calibration values [CRT(P_{1,1}), CRT(P_{1,2}) . . . , CRT(P_{1,7})], [CRT(P_{2,1}), CRT(P_{2,2}) . . . , CRT(P_{2,7})] . . . , [CRT(P_{13,1}), CRT(P_{13,2}) . . . , CRT(P_{13,7})] returned to the operating unit 14 for calibrating the each crossover point on the touch panel 11.

It's worth noting, the channels of the detection front end 12 which are coupled to the touch panel 11 are less than the sensing electrodes RXⱼ of the touch panel 11. Therefore, in the scanning process, classifying the sensing electrodes RXⱼ into a plurality of scanning groups Gₖ (k≧1 and k is an integer), such as the group G₁ and G₂ in FIG. 2. For instance, the baseline calibration unit 13 scans the transmission electrode TX₁ of group G₁ on first-axis by the scanning signals SCAN₁(TX₁)˜SCAN₄(TX₁) sequentially for several times. Calculating each scanning signal SCAN₁(TX₁)˜SCAN₄(TX₁) scans the transmission electrode TX₁ of group G₁ to obtain the average AVG₁(TX₁)˜AVG₄(TX₁) for each scanning signal SCAN₁(TX₁)˜SCAN₄(TX₁) which are belonged to the group G₁.

The baseline calibration unit 13 further bases on the predetermined reference value BKTH, calculating the first group differential value DIF₁(TX₁) belonged the transmission electrode TX₁ of group G₁ from the averages AVG₁(TX₁)˜AVG₄(TX₁) of the scanning signals SCAN₁(TX₁)˜SCAN₄(TX₁) associated the transmission electrode TX₁ of group G₁.

Finally, repeating the step abovementioned to calculating the first group differential values DIF₁(TX₂)˜DIF₁(TX₇) for transmission electrodes TX₂˜TX₇. After completing the group G₁, sequentially scanning and calculating to obtain the second group differential values DIF₂(TX₂)˜DIF₂(TX₇), and then finishing the calculation procedure for transmission electrodes TX₁˜TX₇ arranged along first-axis.

Hereafter, the baseline calibration unit 13 calculates the sensing values of the sensing electrode RX₁ on second-axis, that is the average AVG(RX₁) calculated by the sensing values on the each crossover point P_{1,1}, P_{2,1}, . . . , P_{7,1}. Then, the baseline calibration unit 13 calculates the average AVG(RX₁) with the first group differential value DIF₁(TX₁), DIF₁(TX₂) . . . , DIF₁(TX₇) of the transmission electrodes TX1˜TX7 by the equation (2) to obtain the second differential values DIF₁(RX₁), DIF₂(RX₁) . . . , DIF₇(RX₁) for sensing electrode RX₁ and the second differential values DIF₁(RX₁₁), DIF₂(RX₁₁) . . . , DIF₇(RX₁₁) for sensing electrode RX₁₁ at same time. The baseline calibration unit 13 sequentially calculates the sensing electrodes RX₁˜RX₁₃ arranged along second-axis for touch panel 11 to obtain all the second differential values [DIF₁(RX₁)˜DIF₇(RX₁)], [DIF₁(RX₂)˜DIF₇(RX₂)] . . . , [DIF₁(RX₁₃)˜DIF₇(RX₁₃)] for all the crossover points P_{i,j} of the sensing electrodes RX₁˜RX₁₃ on touch panel 11 until completing the calculation procedure on second-axis.

Then, the baseline calibration unit 13 further calculates the calculating result arranged along second-axis with the calculating result arranged along first-axis (such as the equation (3) above). For calculating all the baseline calibration values CRT(P_{i,j}) of the crossover points P_{i,j} disposed on the touch panel 11.

On another hand, by the classifying groups method for the transmission electrodes TX₁˜TX₇ disposed on the touch panel 11, Thus, in the embodiment of the present disclosure, further using the first group differential values DIF₁(TX₁), DIF₁(TX₂) . . . , DIF₁(TX₇) as the second group differential values DIF₂(TX₁), DIF₂(TX₂) . . . , DIF₂(TX₇) after calculating the first group differential value DIF₁(TX₁), DIF₁(TX₂) . . . , DIF₁(TX₇). In other words, the crossover points P_{1,1}, P_{1,2}, . . . P_{1,10} associated with the transmission electrodes TX₁ decide all the first group differential values DIF(TX₁), DIF(TX₂) . . . , DIF(TX₇) associated with the transmission electrodes TX₁.

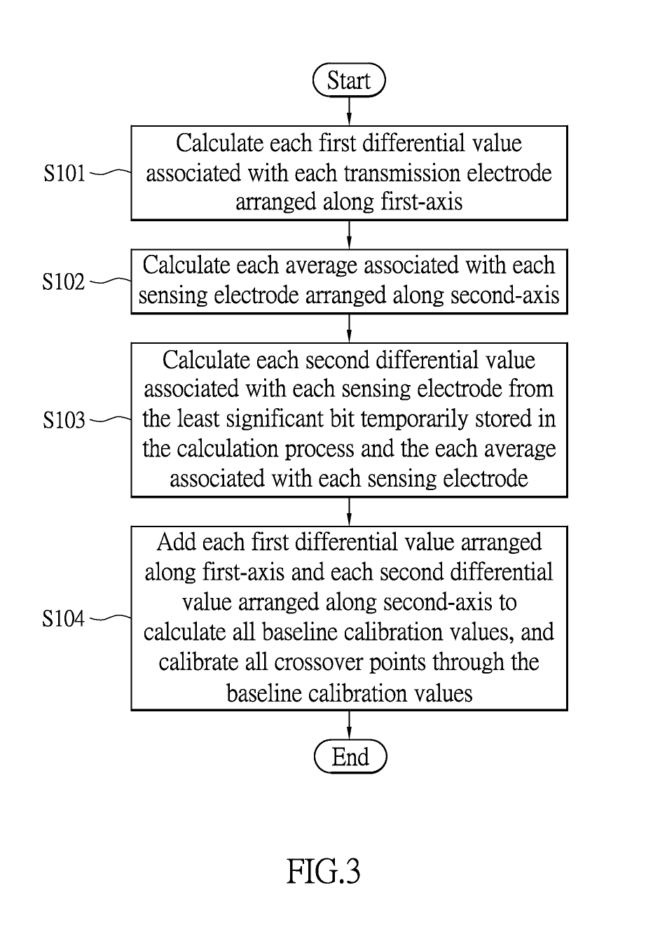

Please synchronously refer FIG. 2 and FIG. 3. FIG. 3 shows a flow diagram of a baseline calibration method according to an embodiment of the present disclosure. The touch panel 11 includes a plurality of transmission electrodes TXᵢ arranged along first-axis and a plurality of sensing electrodes RXⱼ arranged along second-axis, each transmission electrodes TXᵢ and each sensing electrodes RXⱼ form each crossover point wherein the i, j≧1 and the i, j are integers. Firstly, In the step S101, calculate each first differential value DIF(TXᵢ) for each transmission electrode TXᵢ arranged along first-axis. In the step S102, calculate each average AVG(RXⱼ) for each sensing electrode RXⱼ arranged along second-axis. In the step S103, calculate each second differential value DIFᵢ(RXⱼ) associated with each sensing electrode RXⱼ by the least significant bit temporarily stored in the calculation procedure and the each average AVG(RXⱼ) associated with each sensing electrode RXⱼ. In the step S104, adds each first differential value DIF(TXᵢ) arranged along first-axis and each second differential value DIFᵢ(RXⱼ) arranged along second-axis to calculate all baseline calibration values CRT(P_{i,j}), and calibrate all crossover points P_{i,j} through the baseline calibration values CRT(P_{i,j}).

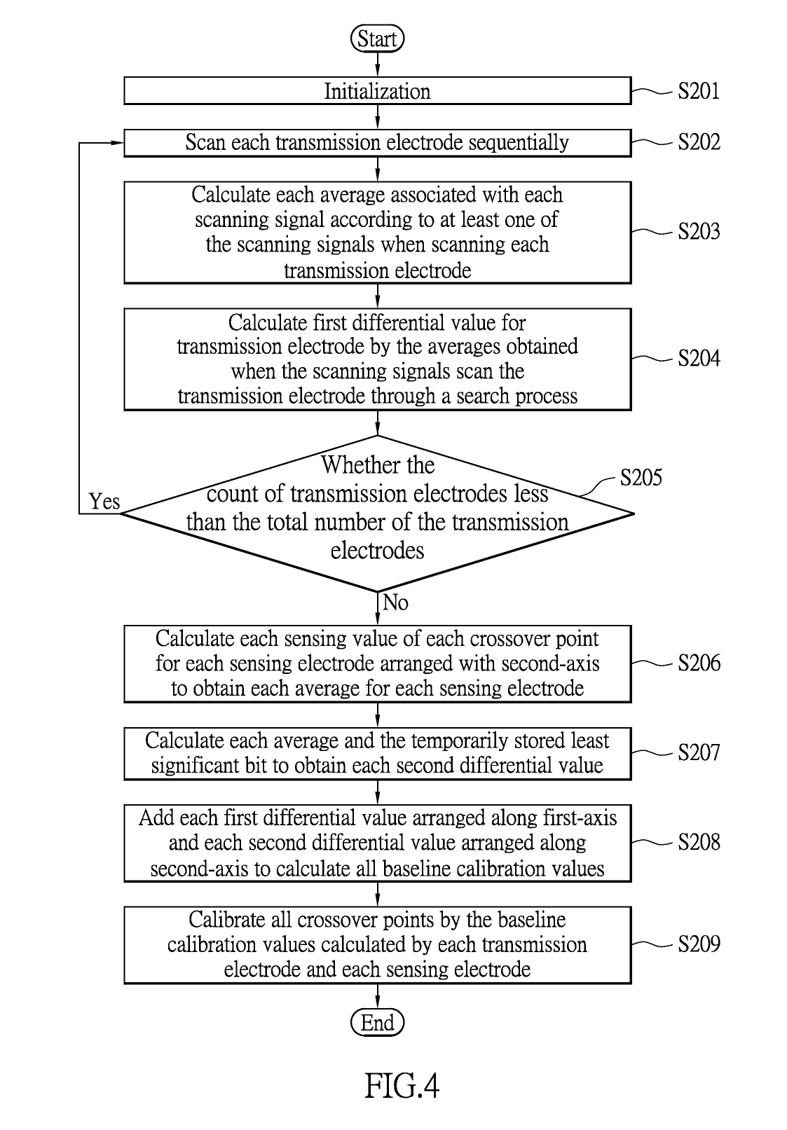

Please synchronously refer FIG. 2 and FIG. 4, FIG. 4 shows a flow diagram of a baseline calibration method according to other embodiment of the present disclosure. The baseline calibration method of the embodiment of the present disclosure comprises a first-axis calculation procedure and a second-axis calculation procedure. The first-axis calculation procedure comprises the step S201, the step S202, the step S203, the step S204 and the step S205. The second-axis calculation procedure comprises the step S206, the step S207, the step S208 and the step S209.

Firstly, in the step S201, the baseline calibration unit 13 will set the initialization. When the user processes the baseline calibrating process, setting the predetermined reference value BKTH, transmission electrodes TXᵢ number and the sensing electrodes RXⱼ number (such as the TX₁˜TX₇ and the RX₁˜RX₁₃ in FIG. 2). The predetermined reference value BKTH is the target that the user wanted for all the crossover points P_{i,j} disposed on the touch panel 11.

In the step S202, scan each transmission electrode TXᵢ sequentially. In carefully, the baseline calibration unit 13 receives a plurality of the scanning signals for scanning the transmission electrode TX₁ sequentially. After finish scanning the transmission electrode TX₁, receive a plurality of the scanning signals for scanning the transmission electrode TX₂ continuously, until complete all the transmission electrodes TXᵢ arranged along first-axis.

In the step S203, calculate each average AVGₐ(TXᵢ) associated with each scanning signal SCANₐ(TXᵢ) according to at least one of the scanning signals SCANₐ(TXᵢ) when scan each transmission electrode TXᵢ. The baseline calibration unit 13 calculates the averages AVGₐ (TXᵢ) belonged to each scanning signal SCANₐ(TXᵢ) associated with each scanning signal SCANₐ(TXᵢ) of the scanning transmission electrodes TXᵢ. When baseline calibration unit 13 receives the scanning signals SCAN₁(TX₁)˜SCAN₄(TX₁) which are scanned the transmission electrodes TX₁, obtain the average AVG₁(TX₁) of the scanning signal SCAN₁(TX₁) by averaging the sensing values of each crossover points P_{1,1}, P_{1,2}, . . . , P_{1,13} which are obtained when scanning signal SCAN₁(TX₁) scans the transmission electrode TX₁. Following, sequentially calculate the scanning signals SCAN₂(TX₁)˜SCAN₄(TX₁) and then obtain the average AVG₂(TX₁)˜AVG₄(TX₁) for each scanning signals SCAN₂(TX₁)˜SCAN₄(TX₁), the calculating is same as the scanning signal SCAN₁(TX₁), it doesn't repeat here.

In the step S204, calculate first differential value DIF(TXᵢ) for transmission electrode TXᵢ by the averages AVGₐ(TXᵢ) obtained when the scanning signals SCANₐ(TXᵢ) scan the transmission electrode TXᵢ through a search process. It's worth noting, in the process for calculating each first differential value DIF(TXᵢ) of each transmission electrode TX store a set of the least significant bits TX₁_{_{—}}LSB(RXⱼ) corresponding to the sensing electrodes RXⱼ. Wherein the calibration bits BKunit is obtained when baseline calibration unit 13 scans the transmission electrode TXᵢ by the scanning signals SCANₐ(TXᵢ), that is the first differential value DIF(TXᵢ). For instance, the baseline calibration unit 13 further bases on the predetermined reference value BKTH in the search process, calculate and obtain the first differential value DIF(TX₁) of the transmission electrode TX₁ from the scanning signals SCAN₁(TX₁)˜SCAN₄(TX₁). The first differential value DIF(TX₁) is the calibration bits BKunit calculated by the transmission electrode TX₁ (such as the scanning signal 0101).

In the step S205, detect whether the count of transmission electrodes TXᵢ less than the total number of the transmission electrodes TXᵢ. In other words, determine whether finish all the transmission electrodes TXᵢ arranged with first-axis calculation procedure. In detail, after the baseline calibration unit 13 finishes the step S202˜S204, detect whether the count of the transmission electrodes TXᵢ are calculated to find all the first differential value DIF(TXᵢ). If not, repeat the step S202˜S204 until find all the first differential value DIF(TXᵢ) for the count of the transmission electrodes TXᵢ which is set in the step S201. The embodiment of the present disclosure further may use the first differential value DIF(TX₁) of the transmission electrode TXᵢ being as other first differential value DIF(TX₂) DIF(TXᵢ). In other words, leapfrog the step S202 and S205 detecting the first differential values DIF(TX₁)˜DIF(TXᵢ) according to the count of other transmission electrodes TX₂˜TXᵢ, just only achieve by the first differential value DIF(TX₁) of the transmission electrode TX₁, the present disclosure is not limited thereto.

Finish the first-axis calculation procedure, in the step S206, the baseline calibration unit 13 will process the second-axis calculation procedure, calculate and obtain each average AVG(RXⱼ) by the sensing values of the crossover points P_{i,j} for each sensing electrode RXⱼ arranged along second-axis.

In the step S207, calculate each average AVG(TXⱼ) and the temporarily stored least significant bit TXᵢ_{_{—}}LSB(RXⱼ) to obtain each second differential value DIFᵢ(RXⱼ). For example, the least significant bit TXᵢ_{_{—}}LSB(RX₁) stores by calculating the first differential value DIF(TX₁) of the transmission electrodes TX₁ in the process with the average AVG(RX₁) of the sensing electrode RX₁ according to the equation (2), and obtains the second differential values DIFᵢ(RXⱼ) of crossover points on the sensing electrode RX₁.

In the step S208, add each first differential value DIF(TXᵢ) on first-axis and each second differential value DIFᵢ(RXⱼ) arranged with second-axis to calculate all baseline calibration values CRT(P_{i,j}).

Finally, in the step S209, calibrate all crossover points P_{i,j} by the baseline calibration values CRT(P_{i,j}) calculated by each transmission electrode TXⱼ and each sensing electrode RXⱼ.

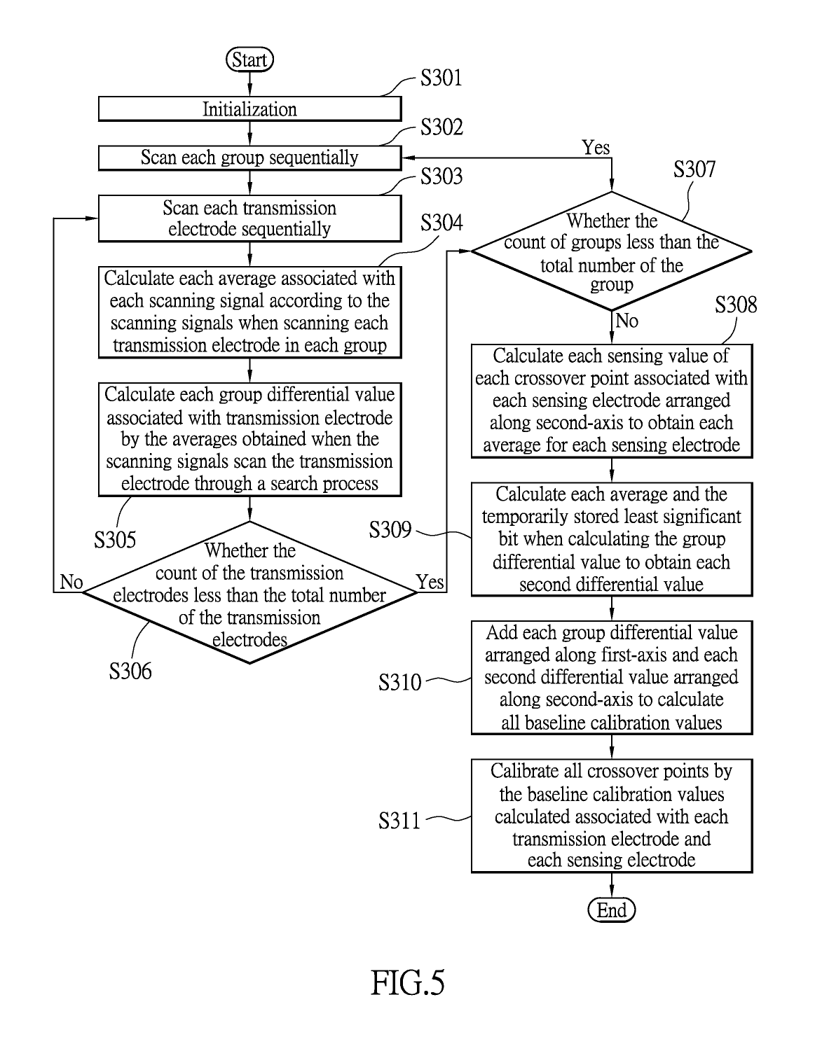

Please refer FIG. 5, FIG. 5 shows a flow diagram of a baseline calibration method according to another embodiment of the present disclosure. The baseline calibration method of the embodiment of the present disclosure comprises a first-axis calculation procedure and a second-axis calculation procedure. The first-axis calculation procedure comprises the step S301, the step S302, the step S303, the step S304, the step S305, the step S306 and the step S307. The first-axis calculation procedure comprises the step S308, the step S309, the step S310 and the step S311.

Firstly, in the step S301, the baseline calibration unit 13 will set the initialization. When the user processes the baseline calibrating process, setting the predetermined reference value BKTH, transmission electrodes TXᵢ number, the sensing electrodes RXⱼ number (such as the TX₁˜TX₇ and the RX₁˜RX₁₃ in FIG. 2) and the groups Gₖ number (such as the group G₁ and the group G₂). The predetermined reference value BKTH is the target that the user wanted for all the crossover points P_{i,j} disposed on the touch panel 11.

In the step S302, scan each group Gₖ sequentially. In carefully, the channels of the detection front end 12 which are coupled to the touch panel 11 are usually less than the sensing electrodes RXⱼ of the touch panel 11. Thus, the scanning process divides the sensing electrodes RXⱼ into several groups Gₖ (k≧1 and k is the integer), such as the group G₁ and G₂ in FIG. 2.

In the step S303, scan each transmission electrode TXᵢ sequentially. In carefully, the baseline calibration unit 13 provides a plurality of the scanning signals SCANₐ(TX₁) for scanning the transmission electrode TX₁ in the group Gₖ sequentially. After finish scanning the transmission electrode TX₁, provide a plurality of the scanning signals SCANₐ(TX₁) for scanning the transmission electrode TX₂ in the group Gₖ continuously, until complete all the transmission electrodes TXᵢ associated with first-axis.

In the step S304, calculate each average AVGₐ(TXᵢ) associated with each scanning signal SCANₐ(TXᵢ) according to the scanning signals SCANₐ(TXᵢ) when scan each transmission electrode TXᵢ in each group Gₖ. For instance, the baseline calibration unit 13 calculates the averages AVGₐ (TXᵢ) belonged to each scanning signal SCANₐ(TXᵢ) for each scanning signal SCANₐ(TXᵢ) of the scanning transmission electrodes TXᵢ in the group G₁. When baseline calibration unit 13 receives the scanning signals SCAN₁(TX₁)˜SCAN₄(TX₁) which are scanned the transmission electrodes TX₁, obtain the average AVG₁(TX₁) of the scanning signal SCAN₁(TX₁) by averaging the sensing values of each crossover points P_{1,1}, P_{1,2}, . . . , P_{1,13} which are obtained when scanning signal SCAN₁(TX₁) scans the transmission electrode TX₁ in the group G₁. Following, sequentially calculate the scanning signals SCAN₂(TX₁)˜SCAN₄(TX₁) and then obtain the average AVG₂(TX₁)˜AVG₄(TX₁) for each scanning signals SCAN₂(TX₁)˜SCAN₄(TX₁), the calculating is same as the scanning signal SCAN₁(TX₁), it doesn't repeat here.

In the step S305, calculate each group differential value DIFₖ(TXᵢ) for transmission electrode TXᵢ by the averages AVGₐ(TXᵢ) obtained when the scanning signals SCANₐ(TXᵢ) scan the transmission electrode TXᵢ through a search process. For example, when calculate each scanning signals SCAN₁(TX₁)˜SCAN₄(TX₁) in the group G₁, the baseline calibration unit 13 further bases on the predetermined reference value BKTH in the search process, calculate the first group differential value DIF₁(TX₁) for the transmission electrode TX₁ in the group G₁. It's worth noting, in the process of calculating the first differential value DIF(TXᵢ) of each transmission electrode TX₁, store a set of least significant bits TX₁_{_{—}}LSB(RX₁)˜TX₁_{_{—}}LSB(RX₁₀) corresponding to the value of the sensing electrode RX₁˜RX₁₀ calculating. In the embodiment of present disclosure, while achieving by the binary search algorithm, but the person skill in the art should understand that can be implemented replacing by the linear search algorithm or other algorithms. The present disclosure is not limited thereto.

In the step S306, detect whether the count of transmission electrodes TXᵢ less than the total number of the transmission electrodes TXᵢ in the group Gₖ arranged with first-axis. If not, return to the step S303 for executing the calculation procedure in the group Gₖ associated with first-axis. If yes, enter the step S307.

After finish the group Gₖ on first-axis calculation procedure, in the step S307, further detect whether completing the group Gₖ in the first-axis calculation procedure, that is detecting whether the count of the group Gₖ less than the total number of the group Gₖ. If not, repeat the step S302˜S307, calculate the other group Gₖ in the first-axis calculation procedure again. If yes, it expresses finishing the first-axis calculation procedure for the touch panel 11, and executing the second-axis calculation procedure.

Then, in the step S308, the baseline calibration unit 13 calculates each sensing value of each crossover point P_{i,j} for each sensing electrode RXⱼ arranged with second-axis to obtain each average AVG(TXⱼ) for each sensing electrode RXⱼ.

In the step S309, calculate each average AVG(TXⱼ) and the temporary stored least significant bit TXᵢ_{_{—}}LSB(RXⱼ) when calculate the group differential value DIFₖ(TXᵢ) to obtain each second differential value DIFᵢ(RXⱼ). In the step S310, add each group differential value DIFₖ(TXᵢ) arranged with first-axis and each second differential value DIFᵢ(RXⱼ) arranged with second-axis to calculate all baseline calibration values CRT(P_{i,j}).

Finally, calibrate all crossover points P_{i,j} by the baseline calibration values CRT(P_{i,j}) calculated by each transmission electrode TXⱼ and each sensing electrode RXⱼ.

It's worth noting, the embodiment of the present disclosure further may use the first group differential value DIF₁(TX₁) of the transmission electrode TXᵢ being as other first group differential values for the sensing values of the crossover points P_{i,j} in other groups Gₖ. In other words, by first time scanning group G₁, the least significant bit TX₁_{_{—}}LSB(RXᵢ) stored in the process of the first group differential value DIF₁(TXᵢ) for the transmission electrodes TXᵢ in the group G₁ decides the whole first differential value DIF(TXᵢ) and after the least significant bit needed by calculating each sensing electrodes RXⱼ on second-axis. For instance, in the transmission electrode TX₁, the least significant bit TX₁_{_{—}}LSB(RX₁) stored in the process of the first group differential value DIF₁(TX₁) for the transmission electrodes TX₁ in the group G₁ is used as the least significant bit TX₁_{_{—}}LSB(RX₁₁) stored originally in the process of the second group differential value DIF₂(TX₁) for the transmission electrodes TX₁₁. The reason is that the divergence between each of the groups Gₖ isn't obvious for the average by calculating from the crossover points P_{i,j}, thence the average calculated by the differential value with the predetermined reference value BKTH also doesn't differ too much similarly. Thus, the embodiment of the present disclosure further reduces the calculation procedure of other groups (such as the step S302 and S307) to upgrade the speed of the calculating by only calculating the group G₁.

In summary, the manufacturing company of the touch panel can improve the judgment accuracy decreased when users employ the touch panel. The improvement is exploiting the baseline calibration unit to resolve the mismatch between each sensing channel or the manufacturing for touch panel originally, and the mismatch may further affect the judgment accuracy. Firstly the baseline calibration unit calibrates the crossover points arranged with first-axis, secondly the baseline calibration unit bases on the result of calibrating the crossover points arranged with first-axis to calibrate the crossover points arranged with second-axis again, so as to cancel the part of the un-flatness for each axis. Therefore, the baseline calibration unit achieves the gradient approximating agreed for whole touch panel, so as to increase the judgment accuracy. It's worth noting, wherein using the method arranged with first-axis and second-axis to calibrate the crossover points may reduce the circuit cost for N²−2N.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

What is claimed is:

1. A baseline calibration method for a touch panel, comprising:
calculating each first differential value associated with each respective transmission electrode through a first-axis calculation procedure;
calculating each second differential value associated with each respective sensing electrode through a second-axis calculation procedure; and
calculating a baseline calibration value based on each of the first differential values and each of the respective second differential values calculated.

2. The baseline calibration method according to claim 1, wherein the first-axis calculation procedure comprises:
setting a predetermined reference value;
scanning a first set of transmission electrodes arranged along a first axis with at least a first scanning signal to calculate a first average, wherein the first average is the average of the sensing values generated at crossover points formed by the first transmission electrode and the respective sensing electrodes; and
utilizing a search process and calculating the first differential values associated with the first transmission electrode based on the predetermined reference value.

3. The baseline calibration method according to claim 1, wherein each of the second differential values is calculated from a least significant bit, which is temporarily stored and is calculated using a second average and each of the respective first differential values, wherein, the second average is the average of the sensing values generated at the crossover points formed by each of the sensing electrodes and the respective the first transmission electrode.

4. The baseline calibration method according to claim 2, further comprising:
scanning a second set of transmission electrodes arranged along a first axis with at least a second scanning signal to calculate the first average, wherein the first averages is the average of the sensing values generated at the crossover points formed by the second transmission electrode and the respective sensing electrodes; and
utilizing the search process and calculating the first differential value associated with the second transmission electrode based on the predetermined reference value.

5. The baseline calibration method according to claim 1, further comprising:
calibrating each crossover point with each of the baseline calibration values, wherein each crossover point is formed by each of transmission electrodes and each of the respective sensing electrodes.

6. The baseline calibration method according to claim 2, wherein the search process is implemented using a binary search algorithm.

7. The baseline calibration method according to claim 2, wherein the sensing electrodes are classified into at least one of scanning groups according to the number of channels associated with a detection front end (DFE) which is coupled to the touch panel.

8. The baseline calibration method according to claim 7, further comprising:
calculating a first group average associated with the first transmission electrode in a first scanning group using the sensing values sensed by each respective sensing electrode, wherein each of the sensing values is generated at each of the crossover points associated with each respective sensing electrode after scanning the first transmission electrode in a first scanning group.

9. The baseline calibration method according to claim 8, wherein a first group differential value associated with the first transmission electrode in the first scanning group is calculated according to the first group averages of the transmission electrodes in the first scanning group.

10. The baseline calibration method according to claim 7, further comprising:
calculating a second group average associated with the first transmission electrode in a second scanning group using the sensing values sensed by each respective sensing electrode, wherein each of the sensing values is generated at each of the crossover points associated with each sensing electrode after scanning the first transmission electrode in a second scanning group.

11. The baseline calibration method according to claim 10, wherein a second differential value associated with the first transmission electrode in the second scanning group is calculated according to the first group averages of the transmission electrodes in the second scanning group.

12. The baseline calibration method according to claim 9, wherein the first group differential value calculated is used as the first differential value.

13. A baseline calibration system, comprising:
a touch panel having a plurality of transmission electrodes and sensing electrodes disposed thereon, the transmission electrodes being arranged on the touch panel along a first axis and the sensing electrodes being arranged along a second axis, wherein each of the transmission electrodes and each of the respective sensing electrode form a crossover point; and
a baseline calibration unit, coupled to the touch panel;
wherein the baseline calibration unit calculates each first differential value associated with each transmission electrode through a first-axis calculation procedure and calculates each second differential value associated with each sensing electrode through a second-axis calculation procedure; the baseline calibration unit calculates a baseline calibration value based on each of the first differential value and each of the respective second differential value.
